(19) United States
(12) Patent Application Publication
(10) Pub. No.: US 2017/0311403 A1
(43) Pub. Date: Oct. 26, 2017

(54) SYSTEM FOR ADAPTIVE NON-LINEAR LIGHT DIMMING OF ELECTRO-OPTICAL DEVICES

(71) Applicant: Sagem Avionics LLC, Grand Prairie, TX (US)

(72) Inventors: Vanacan Tatavoosian, Mission Viejo, CA (US); Jianming Yuan, Tustin, CA (US); Brian Pham, San Gabriel, CA (US)

(21) Appl. No.: 15/520,797

(22) PCT Filed: Oct. 30, 2015
(86) PCT No.: PCT/US2015/058510

§ 371 Date: Apr. 20, 2017

Related U.S. Application Data
(60) Provisional application No. 62/073,680, filed on Oct. 31, 2014.

(51) Int. Cl. H05B 33/08

(52) U.S. Cl. CPC H05B 33/0845; H05B 33/0827

(57) ABSTRACT

System for adaptive non-linear light dimming of electro-optical devices comprises main transistor, resistance element coupled to drain of main transistor, light-emitting bank including at least one light-emitting device, and luminance adjustment circuitry coupled to source of main transistor. Luminance adjustment circuitry causes input voltage to the system to have a non-linear relationship with current through light-emitting bank. Luminance adjustment circuitry includes slope-point components coupled in parallel. When a first predetermined voltage level is supplied to the system, the first slope-point component allows a first predetermined amount of current to flow to the light-emitting bank, and when a second predetermined voltage level is supplied to the system, the first slope component allows the first predetermined amount of current to flow to the light-emitting bank and the second slope-point component allows a second predetermined amount of current flow to the light-emitting bank.

### CROSS-RELATED REFERENCES

This application claims the benefit pursuant to 35 U.S.C. 119(e) of U.S. Provisional Application No. 62/073,680, filed Oct. 31, 2014, which application is specifically incorporated herein, in its entirety, by reference.

### FIELD

Embodiments of the disclosure relate generally to systems for adaptive non-linear light dimming of solid state electro-optical devices, such as light-emitting diodes (LEDs). Specifically, producing the dimming control of an LED according to a non-linear target dimming curve that enables precise control over a large dynamic dimming range of the non-linear target dimming.

### BACKGROUND

Light-emitting diodes (LEDs) are becoming increasingly popular in numerous applications and fields as they are typically more reliable, more efficient and less expensive than other light source device types, such as incandescent lamps. However, the linear dimming characteristics of LEDs are not ideal for all applications especially for human visual perception and interpretation. For instance, the linear characteristics of LEDs illuminating displays are not ideal for day and night application environments. Brightness and dimming of a display, illuminated by LED(s) would appear unacceptable and too slow in day and too fast (not controllable) at night (dim environment). Therefore a nonlinear dimming capability with fast dimming for day and slow dimming for night is highly desirable. Ideally a 1500 to 1 dynamic ratio of nonlinear dimming range is highly desirable to satisfy human visual perception in application environment such as cockpit of an aircraft.

The linear dimming characteristics of LEDs cause dramatic changes in the luminance of a LED. As the dimming of a LED follows a linear curve (e.g., a straight line), the change in luminance may be too great between two portions of the linear dimming curve given particular features of the environment in which the LED is located (e.g., the amount of ambient light present). The dramatic change in luminance of the LED may be noticeable to a viewer and may even appear as an abruption (flickering) of light as the luminance of the LED is decreased in a linear manner. In some instances, such as in an aircraft, abruption of (flickering) lights may signify a malfunction of equipment; therefore, it is not ideal to have a display signal illuminated by LED(s) to provide wrong indication while the LED(s) dimmed.

In addition, precision of dimming a LED may be desired beyond the precision that can be provided by a LED having linear dimming characteristics. As discussed above, the rate of change between two points on a linear dimming curve may not allow an operator of a LED to obtain the desired luminance value for at least one LED.

For example, the cockpit of an aircraft may include numerous control knobs, dials, displays, Advisory-Caution-Warning lights, etc. In such an environment, the increasing and decreasing of each LED luminance must be controlled precisely and with ease to allow the aircraft operator to obtain the proper luminance level for each control knobs, dials, displays, Advisory-Caution-Warning lights, etc. Therefore, current LEDs having linear dimming characteristics do not provide an adequate level luminance fidelity for dimming the luminance level in such environments.

An attempt may be made to achieve non-linear target dimming characteristics with a LED drive circuitry by using a step-function to approximate a non-linear target dimming curve. The use of a step-function to approximate a non-linear target dimming curve may cause dramatic changes in the luminance of the LED that are noticeable to the human eye. In particular, the step-function may cause the LED to appear as if it is flickering when that is not the intention. In some environments, such as in the cockpit of an aircraft as discussed above, a flickering light may signify a malfunction or wrong indication. Therefore, the use of a step-function to approximate a non-linear target dimming curve is not ideal in many environments sensitive to changes in the luminance of at the display when illuminated by one or multiple LEDs.

Alternatively, achieving non-linear dimming characteristics with a LED may be done using a microprocessor and/or a microcontroller digitally. However, the high cost of software certification using a microprocessor compared to the cost of discrete circuit components is inhibiting in devices such as an illuminated pushbutton annunciator (PBA) in an aircraft cockpit. Additionally, microcontrollers require the use of software and the high cost of writing software further inhibits the use of microcontrollers for achieving non-linear dimming characteristics with a LED. Furthermore, digital systems' using microprocessors and software requires Electro-Magnetic Interference (EMI) protection and certification which adds significant cost of development and to the display device cost. However, in many situations, such as when an illuminated PBA is used inside an aircraft cockpit, there is no tolerance for software crashes or opportunities to reboot the system when the aircraft is in flight. Therefore, the use of microprocessors and/or microcontrollers to achieve non-linear dimming characteristics using a LED is not ideal or practical.

As the current state of LED dimming technology does not provide ideal dimming characteristics for most of day and night application environments, it would be advantageous to provide a compact and space efficient electrical drive circuit for dimming LED(s) that is comprised of discrete devices and approximates a non-linear target dimming curve precisely without the use of a step-function or other complex digital-software solutions.

Accordingly, there is a need for a LED dimming technology that is adaptive to many ambient lighting applications, provides a desirable visual dimming of large dynamic luminance range, and is compact or only requires small space.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 is a graph illustrating an exemplary target non-linear dimming curve for luminance performance of an electro-optical device according to one embodiment of the invention.

FIG. 2 is a block diagram of an exemplary system for adaptive non-linear light dimming of electro-optical devices according to one embodiment of the invention.

FIG. 3 is a circuit diagram of the exemplary system for adaptive non-linear light dimming of electro-optical devices in FIG. 2 according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

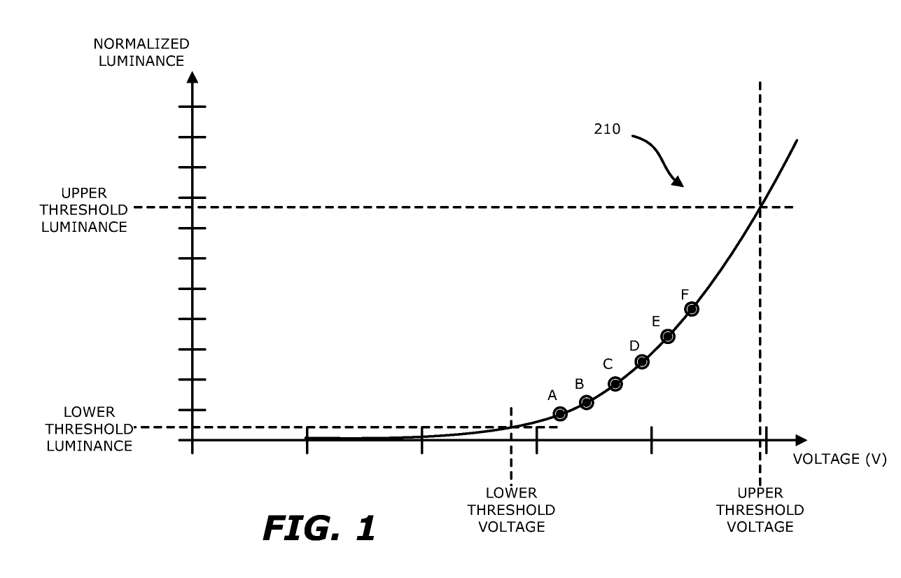

FIG. 1 is a graph illustrating an exemplary target non-linear dimming curve for luminance performance of an electro-optical device according to one embodiment of the invention. An electro-optical device may be for instance a light-emitting device such as an LED bank. The LED bank may consist of a single LED or a plurality of LEDs electrically connected and acting in concert. The LED bank may emit light of various colors including, for example, white, yellow, green, blue, and red.

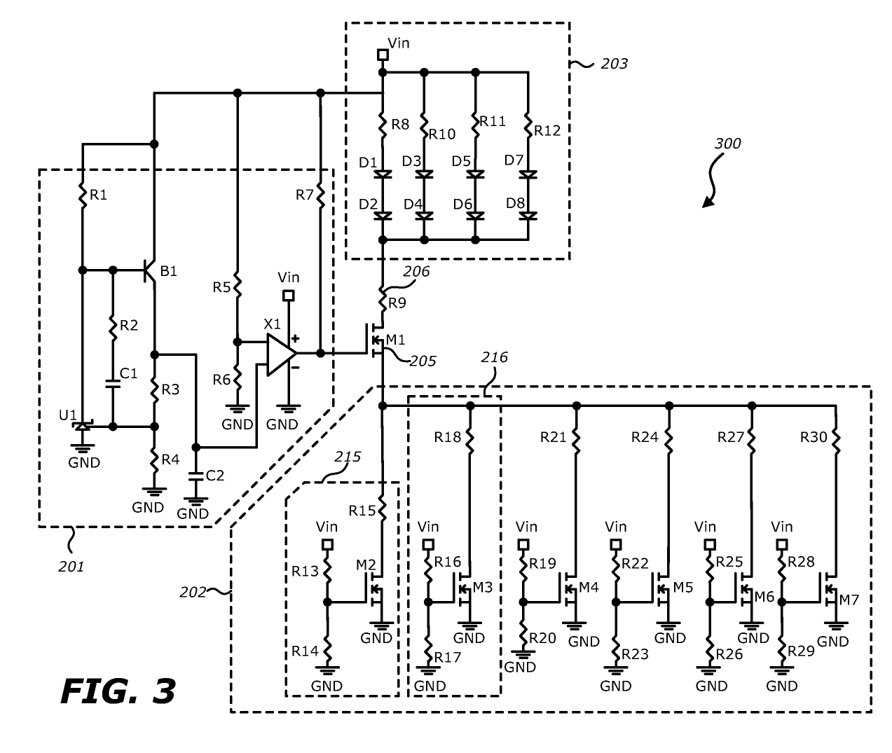

In FIG. 1, the graph includes an x-axis that represents the voltage in volts (V) of the LED bank and a y-axis that represents the normalized luminance. Embodiments of the invention aim to more precisely control the luminance of the LED bank over the luminance values of the entire range of the dimming curve. In addition, the graph also includes in dashed lines a normalized upper threshold luminance and a normalized lower threshold luminance. The normalized upper and lower threshold luminance may correspond to an upper and lower threshold luminance expressed in foot lambert (fL). For example, the upper threshold luminance may be set at 350 fL to accommodate the needs of human eye perception and the ambient lighting. The lower threshold luminance may be a predetermined cutoff threshold at which it is no longer desirable to provide power to the LED bank. For example, at 0.10 fL and lesser luminance levels, it may be predetermined that the luminance of the LED bank is so low that it is barely perceivable by the human eye as being “on.” Accordingly, the voltage supplied to the LED bank may be set to 0 below the lower luminance threshold. As shown in FIG. 1, upper and lower threshold voltages that correspond to the upper and lower threshold luminance are established using the target dimming curve 210 for the luminance performance. An upper threshold slope point is the point on the target non-linear dimming curve 210 corresponding to the upper threshold voltage and the upper threshold luminance value and a lower threshold slope point is the point on the target non-linear dimming curve 210 corresponding to the lower threshold voltage and the lower threshold luminance value. In one embodiment, the lower threshold voltage may be low voltage (e.g. 6V, where the cut-off and shut-off (by cut-off circuitry 201 in FIG. 3) occurs.

As shown in FIG. 1, the portion of the target dimming curve 210 for the luminance performance of the LED bank between the upper and lower threshold slope-points illustrates that the desired luminance of the LED bank decreases with the decreasing voltage supplied to the LED bank. Similarly, the portion of the target dimming curve 210 between the upper and lower threshold slope-points illustrates that the desired luminance of the LED bank increases with the increasing voltage supplied to the LED bank. In other words, the target dimming curve 210 is non-linear in FIG. 1 such that the changes in the luminance of the LED bank are not dramatic for the lower luminance ranges when dimming or brightening the LED bank. Conversely the LED bank luminance changes are faster for the upper luminance range when dimming or brightening the LED bank. Further, in contrast to the step-function dimming curves, the target non-linear dimming curve 210 in FIG. 1 will allow the LED bank to display non-linear dimming characteristics without appearing to be flickering.

Using the target non-linear dimming curve 210, a plurality of slope-points are selected. In some embodiments, the number of slope points that are selected may be six or more. A slope-point may be a selected voltage-to-luminance pair (voltage-luminance) that establishes the desired luminance at a specific voltage supplied to the LED bank. In one embodiment, the slope-points are selected from the target non-linear dimming curve 210 between the upper and lower threshold slope-points as illustrated in FIG. 1 (e.g., slope-points A-F). In one embodiment, the slope-points are determined based on at least one circuit design constraint or based on a predetermined acceptable visual discrimination deviation threshold from the target non-linear dimming curve 210. In one embodiment, when selecting the two subsequent slope-points (e.g., slope-points A-B), the slope between the two subsequent slope points corresponds to a change in luminance that is not noticeable away from the target curve, to the human eye. In one embodiment, the slope is not a fixed value because at higher luminance (e.g., 300 fL and 350 fL), the human eye cannot perceive the deviation whereas at a lower luminance a change or deviation corresponding to 15 fL may be more noticeable by the human eye. In one embodiment, the target non-linear dimming curve 210 may be established by first choosing a plurality of contiguous slope-points based on a desired slope between each subsequent slope-point and then, constructing the curve 210 by connecting the subsequent slope-points to obtain a continuous curve. In one embodiment, by selecting a minimal number of slope-points (e.g., six or more) that allows for a deviation that is the least perceived between two subsequent slope-points, the required corresponding circuitry (e.g., luminance adjustment circuitry 202) used to implement the slope-points is also minimized (e.g., less components needed and cost-effective) while remaining robust.

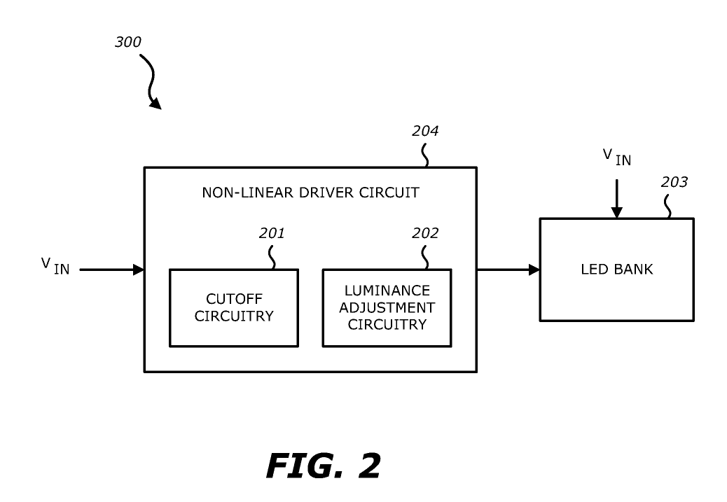

As illustrated in FIG. 1, the target non-linear dimming curve 210 is a power curve (e.g y=x^{a}+b, where a >1). In one embodiment, the power curve is y=x^{3.4}. However, it is understood that the target non-linear dimming curve 210 may be illustrative of a polynomial function, a transcendental function, a monotonic function, etc. FIG. 2 is a block diagram of an exemplary system for adaptive non-linear light dimming of electro-optical devices according to one embodiment of the invention. The system 300 includes a non-linear driver circuit 204 and a light source bank (or LED bank) 203. The non-linear driver circuit 204 implements the dimming characteristics of the target non-linear dimming curve in FIG. 1 using the selected slope-points and discrete circuit components. The non-linear driver circuit 204 may include a cutoff circuitry 201 that cuts off the power supplied to the LED bank 203 and a luminance adjustment circuitry 202 that varies the voltage supplied to the LED bank 203 to adjust the luminance of the LED bank 203 in accordance to the characteristics of the target non-linear dimming curve 201 in FIG. 1. The LED bank 203 may consist of a single LED or a plurality of LEDs electrically connected and acting in concert. The LED bank 203 may emit light of various colors including, for example, white, yellow, green, blue, and red.

The system 300 may find use in a number of different fields and applications. For example, the system 300 may find use in various portions of an aircraft, including cockpit control panels, cabin lighting, and other lit portions of an aircraft. In some embodiments, the system 300 may be used to implement a pushbutton annunciator (PBA). The system 300 is not limited to use in aircraft, however. Instead, the system 300 may find use in any application or field involving lights and light dimming, particularly in fields and applications including the use of LEDs or other light-emitting devices that have a generally linear relationship between current and luminance (or brightness).

FIG. 3 is a circuit diagram of the exemplary system for adaptive non-linear light dimming of electro-optical devices in FIG. 2 according to one embodiment of the invention. As shown in FIG. 3, the system 300 includes the cutoff circuitry 201 and the luminance adjustment (control) circuitry 202 of the non-linear driver circuit 204 coupled to the LED bank 203. In this embodiment, a power supply that provides an input voltage (Vin) is coupled to the cutoff circuitry 201, the luminance adjustment circuitry 202, and the LED bank 203. The input voltage may be continuously variable over a particular voltage range or may be a discrete set of input voltages.

The LED bank 203 may comprise one or more LEDs. In FIG. 3, the LED bank 203 includes a plurality of diodes (D1-D8) and a plurality of resistors (R8-R12). The plurality of diodes (D1-D8) may be LEDs. As shown in FIG. 3, the LED bank 203 may include a plurality of LED bank components. Each LED bank component may include one resistor (e.g., resistor R8) that is connected in series with the two diodes (e.g., diodes D1 and D2). Each LED bank components may also be connected to each other in parallel.

The system 300 also includes a resistance element 206 (e.g., a resistor (R9)) and a metal-oxide-semiconductor field-effect transistor (MOSFET) (M1) 205. The resistor (R9) 206, the cutoff circuitry 201, and the luminance (control) adjustment circuitry 202 is configured and electrically coupled with the LED bank 203 so that an input voltage (Vin) has a non-linear relationship with the electrical current through the LED bank 203 and with the luminance of the LED bank 203.

While the resistor (R9) 206 is illustrated as a single resistor in FIG. 3, the resistance may include one or more components (e.g., passive components) for providing an electrical resistance. For example, the resistance may include two or more resistors and/or other components that provide electrical resistance. While FIG. 3 illustrates the MOSFET (M1) 205, one or more transistors known in the art capable of provided the functionality described herein may be used in system 300 in lieu of the single MOSFET (M1) 205.

Referring back to the embodiment in FIG. 3, the gate of the MOSFET (M1) 205 is coupled to the cutoff circuitry 201, the source of the MOSFET (M1) 205 is coupled to the luminance adjustment circuitry 202, and the drain of the MOSFET (M1) 205 is coupled to the resistor (R9) 206. The resistor (R9) 206 is coupled to the LED bank 203. In some embodiments, the resistor (R9) 206 is connected in series with the LED bank 203. In an embodiment, the luminance adjustment circuitry 202, the current path of the MOSFET (M1) 205 (e.g., from source to drain), the resistor (R9) 206 and the LED bank 203 may be in series.

The cutoff circuitry 201 is coupled to the LED bank 203 to shut off the power supply to the LED bank 203 by cutting the current flow to the LED bank 203. Referring to FIG. 3, the cutoff circuitry 201 includes a plurality of capacitors (C1-C2), a bipolar junction transistor (BJT) (B1), a plurality of resistors (R1-R7), a voltage amplifier (X1), and a Zener diode (U1). The cutoff circuitry 201 includes at least one portion coupled to the power source that provides the input voltage (Vin) and at least one portion coupled to a ground connection. In some embodiments, portions of the cutoff circuitry 201 may be connected in parallel with the LED bank 203.

The luminance adjustment circuitry 202 includes a plurality of slope-point components (e.g., slope-point components 215, 216). In one embodiment, each slope-point component (e.g., 215) includes a plurality of resistors (e.g., R13, R14, R15) and a transistor (e.g., MOSFET (M2)). For example in the slope-point component 215, the gate of the MOSFET (M2) is coupled to the resistors R13 and R14, which are coupled respectively to the power source providing the input voltage (Vin) and a connection to ground. The source of the MOSFET (M2) is connected to ground and the drain of the MOSFET (M2) is connected to resistor (R15) which may be a resistor for the slope-point component 215. Each of the slope-point components is connected in parallel and coupled to the source of the MOSFET (M1) 205.

In the embodiment in FIG. 3, the luminance adjustment circuitry 202 includes six slope-point components. Each slope-point component corresponds to a slope-point selected using the non-linear target dimming curve 210 in FIG. 1. In other embodiments, the shape and slope of the non-linear target dimming curve 210 (e.g., polynomial, different power curve, monotonic, etc.) may differ from that in FIG. 1, such that the slope-points selected therefrom also differ. In this embodiment, the luminance adjustment circuitry 202 may be adaptive in that the slope-point components correspond to the slope-points selected from the non-linear target dimming curve, accordingly. Upon application of power to the circuit, each slope-point component according to an approximation of non-linear target dimming curve 210 may provide power to the LED bank 203 sequentially as the voltage (Vin) supplied to the circuit increases.

When a first predetermined voltage level is supplied to the circuit, a first slope-point component 215 allows a first predetermined amount of current to flow to the LED bank 203. It may be stated that when a slope-point component allows current to flow to the LED bank, the slope-point component is “turned on.”

As the input voltage is increased to a second predetermined voltage level, the first slope-point component 215 continues to allow the first amount of current to flow to the LED bank 203 and a second slope-point component 216 allows a second predetermined amount of current to flow to the LED bank 203. Therefore, when the second predetermined voltage level is supplied to the circuit, the first predetermined amount of current and the second predetermined amount of current are permitted to flow to the LED bank 203. In this embodiment, the LED bank 203 will generate a greater luminance value when both the first predetermined amount of current and second amount of current are permitted to flow to the LED bank 203 than when only the first predetermined amount of current is permitted to flow to the LED bank 203. In other words, in one example, as the number of slope-point components are “turned on”, the luminance of the LED bank 203 increases gradually. Further, as the input voltage (Vin) is increased to a subsequent predetermined voltage level, the first and second slope-point components 215, 216 continue to allow the first amount and second amount of current to flow to the LED bank 203 and a subsequent slope-point component allows a subsequent predetermined amount of current to flow to the LED bank 203.

Similarly, the luminance adjustment circuitry 202 may operate to gradually decrease the luminance of the LED bank 203. For example, when the input voltage is below the second predetermined voltage level but above the first predetermined voltage level, the second predetermined amount of current that was previously allowed to flow to the LED bank 203 is decreased to the first predetermined amount of current. Accordingly, LED bank 203's luminance is decreased gradually and non-linearly with respect to the input voltage.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

In embodiments the invention, the system 300 is thus adaptive to many ambient lighting applications, and provides the desirable visual and photometric dimming for a large dynamic luminance range. Due to the selection of slope-points on a target non-linear dimming curve as discussed above, the system 300 is compact in that it requires small real estate space which is ideal for miniaturization.

What is claimed is:

1. A system for adaptive non-linear light dimming of electro-optical devices comprising:
a main transistor;
a resistance element coupled to a drain of the main transistor;
a light-emitting bank including at least one light-emitting device, wherein the light-emitting bank is coupled in series with the resistance; and
a luminance adjustment circuitry coupled to a source of the main transistor, the luminance adjustment circuitry configured to cause an input voltage to the system to have a non-linear relationship with a current through the light-emitting bank,
wherein the luminance adjustment circuitry includes a plurality of slope-point components coupled in parallel, the plurality of slope-point components include a first slope-point component and a second slope-point component,
wherein, when a first predetermined voltage level is supplied to the system, the first slope-point component allows a first predetermined amount of current to flow to the light-emitting bank, and when a second predetermined voltage level is supplied to the system, the first slope component allows the first predetermined amount of current to flow to the light-emitting bank and the second slope-point component allows a second predetermined amount of current flow to the light-emitting bank.

2. The system of claim 1, wherein, when a voltage level below the second predetermined voltage level but above the first predetermined voltage level is supplied to the system, the first slope component allows the first predetermined amount of current to flow to the light-emitting bank and the second slope-point component does not allow the second predetermined amount of current to flow to the light-emitting bank.

3. The system of claim 2, wherein each of the slope-point components includes a plurality of resistors and a transistor.

4. The system of claim 3, further comprising:
a cutoff circuitry coupled to a gate of the transistor, wherein the cutoff circuitry cuts off input voltage supplied to the light-emitting bank.

5. The system of claim 4, further comprising a power supply to supply the input voltage to the cutoff circuitry, the light-emitting bank, and the luminance adjustment circuitry.

6. The system of claim 1, wherein the light-emitting bank is a light-emitting diode (LED) bank including at least one LED.

7. The system of claim 1, wherein the resistance element is a single resistor.

8. The system of claim 1, wherein the main transistor is a metal-oxide-semiconductor field-effect transistor (MOSFET).

9. The system of claim 1, wherein the first predetermined voltage level, the first predetermined amount of current, the second predetermined voltage level, and the second predetermined amount of current are based on a target non-linear dimming curve that relates the input voltage to a luminance of the light-emitting bank.

10. The system of claim 9, wherein the target non-linear dimming curve illustrates that a desired luminance of the light-emitting bank decreases non-linearly and gradually with the decreasing voltage supplied to the light-emitting bank.

11. A luminance adjustment circuitry for adaptive non-linear light dimming of a light-emitting bank comprising:
a plurality of slope-point components coupled in parallel, the plurality of slope-point components include a first slope-point component and a second slope-point component,
wherein the luminance adjustment circuitry is configured to cause an input voltage to the luminance adjustment circuitry to have a non-linear relationship with a current through the light-emitting bank,
wherein, when a first predetermined voltage level is supplied to the system, the first slope-point component allows a first predetermined amount of current to flow to the light-emitting bank, and when a second predetermined voltage level is supplied to the system, the first slope component allows the first predetermined amount of current to flow to the light-emitting bank and the second slope-point component allows a second predetermined amount of current flow to the light-emitting bank.

12. The luminance adjustment circuitry of claim 11, wherein, when a voltage level below the second predetermined voltage level but above the first predetermined voltage level is supplied to the system, the first slope component allows the first predetermined amount of current to flow to the light-emitting bank and the second slope-point component does not allow the second predetermined amount of current to flow to the light-emitting bank.

13. The luminance adjustment circuitry of claim 12, wherein each of the slope-point components comprises:
a transistor, wherein a source of the transistor is coupled to a ground connection; and
a plurality of resistors including a first resistor, a second resistor, and a third resistor, wherein the first resistor is coupled to the ground connection and to the second resistor, wherein the second resistor is coupled to a power supply to receive a input voltage, wherein a gate of the transistor is coupled to the first and second resistors, and wherein the drain of the transistor is coupled to the third resistor.

14. The luminance adjustment circuitry of claim 13, wherein in each of the slope-point components, the third resistor is coupled to a source of a main transistor that electrically couples the luminance adjustment circuitry to the light-emitting bank.

15. The luminance adjustment circuitry of claim 14, wherein the light-emitting bank is a light-emitting diode (LED) bank including at least one LED.

16. The luminance adjustment circuitry of claim 15, wherein the first predetermined voltage level, the first predetermined amount of current, the second predetermined voltage level, and the second predetermined amount of current are based on a target non-linear dimming curve that relates the input voltage to a luminance of the light-emitting bank.

17. The luminance adjustment circuitry of claim 16, wherein the target non-linear dimming curve illustrates that a desired luminance of the light-emitting bank decreases non-linearly and gradually with the decreasing voltage supplied to the light-emitting bank.
